(19) United States
(12) Patent Application Publication
(10) Pub. No.: US 2021/0339289 A1
(43) Pub. Date: Nov. 4, 2021

(54) SMART RETURN RECEPTACLE

(71) Applicant: Sperry Product Innovation, Inc., Bedford, MA (US)

(72) Inventor: Laurence B. Sperry, Newton, MA (US)

(21) Appl. No.: 17/201,791

(22) Filed: Mar. 15, 2021

Related U.S. Application Data
(60) Provisional application No. 63/019,678, filed on May 4, 2020.

(51) Int. Cl. B07C 5/10; G06K 9/00; G06K 7/10; G07C 9/32

(52) U.S. Cl. CPC B07C 5/10; G06K 9/00771; G06K 2209/01; G06K 7/10297; G07C 9/32; G06K 7/10366

(57) ABSTRACT

A return receptacle system which uses a detection system to guide the user to deposit items into the correct receptacle. The system detects the item to be deposited and provides guidance or instruction to properly deposit the item. In addition, or alternatively, the system allows access to only the appropriate receptacle opening. Additional detection systems and/or sensors may be provided to monitor or ensure only the appropriate items are deposited.

### CROSS-REFERENCE TO RELATED APPLICATION(S)

This application claims priority to, and the benefit of, co-pending U.S. Provisional Application No. 63/019,678, filed May 4, 2020, for all subject matter common to both applications. The disclosure of said provisional application is hereby incorporated by reference in its entirety.

### FIELD OF THE INVENTION

The present invention relates to return receptacles for collecting, trash, recyclables, or reusable items (such as dishware or glassware). In particular, the present invention relates to a smart return receptacle that identifies and directs items to the appropriate bin of the return receptacle.

### BACKGROUND

Conventional receptacles for collecting reusable or recyclable items, such as cups and bottles, are simply marked with words or pictures to indicate the appropriate items for that particular receptacle. Often there are multiple receptacles in the same area for collecting different categories of items, such as separate receptacles for compostable items, recyclable items, reusable items (such as dishware or glassware), and trash. The markings of such receptacles can often be confusing for people to correctly deposit the correct items into the corresponding receptacle. Furthermore, it is a common occurrence that people are in a rush or simply lack the courtesy to ensure they are depositing items into the correct receptacle.

Varying the size and shape of the opening(s) of the receptacle are frequently used as a guide to indicate the shape and size of the objects intended to be deposited, but often objects of similar size get deposited into the wrong receptacle. Additionally, since many smaller items can fit into any receptacle opening, the variety of sizes and shapes of openings do not actively prevent incorrect items from being deposited through the opening. Items deposited into the incorrect receptacle can, at the very least, cause additional labor to be required at a later time to sort out said items from the correct items. If such items are not sorted out, they could alter the effectiveness or damage the equipment involved with washing, recycling, composting, or otherwise processing the items.

Some systems exist, such as automated bottle and can redemption systems, which scan the barcode of items that are entered in the system. While items with barcodes that are programmed to be accepted into the system are conveyed further, items with other barcodes or the lack of a readable barcode are not. Such items may be automatically conveyed to a reject bin, or the user may be asked to remove the rejected item. While such systems prevent incorrect items from being conveyed further into the system, they do not actively prevent incorrect items from being entered into the system in the first place. As such, a user can still, either accidentally or maliciously, enter items into the system opening.

### SUMMARY

There is a need for a return receptacle that will actively guide users to return or discard items into the intended receptacle, such as when discarding used items at self-service restaurants, to increase the probability that items end up in the correct receptacles. The present invention provides a system that will identify items prior to being returned or discarded into a receptacle, and guide the user to return or discard the item to the correct receptacle, such as by using a light system to highlight said receptacle. Additionally, such system may alert the user, as well as alert others in the area or remotely, when items are returned or discarded incorrectly. To further ensure only the intended items are entered into a receptacle, the opening of the receptacle can include a door that will only unlock or automatically open when the intended items are detected.

In accordance with an embodiment of the present invention a smart return receptacle is provided. The smart return receptacle includes one or more bins, an item identification system, and a director mechanism. The one or more bins receive returned or discarded items. The item identification system includes a processor and a scanner or image capture device in communication with the processor that reads identifying tags disposed on the items or performs a capture for character or object recognition. The item identification system identifies items to be placed in the one or more bins when they are positioned within a predetermined range of the scanner or image capture device. The director mechanism facilitates delivery of an identified item to the appropriate bin based on the item identification.

In accordance with aspects of the present invention, the one or more bins comprise at least one of a trash bin, a recycling bin, and a reusable food or beverage return bin.

In accordance with aspects of the present invention, each of the one or more bins has an opening. In certain aspects, each opening has a predetermined perimeter profile shape that differs from each other opening.

In accordance with aspects of the present invention, the scanner is an optical scanner. In other aspects, the image capture device is a camera. In still other aspects, the scanner device is a radio frequency identification (RFID) reader. In some such aspects the RFID reader is a near-field communication (NFC) reader.

In accordance with aspects of the present invention, the director mechanism includes one or more visual indicators communicating feedback information to a user. In other aspects, the director mechanism includes one or more access doors selectively allowing or preventing access to the one or more bins based on identification information collected by the identification system. In yet other aspects, the director mechanism includes a moving platform holding the one or more bins that moves the appropriate bin into position for receiving the identified item based on identification information collected by the identification system. In still other aspects, the director mechanism includes a conveyer system that delivers an identified item to the appropriate bin based on identification information collected by the identification system.

In accordance with aspects of the present invention, the director mechanism further includes an item verification system for verifying that the identified item is received by the appropriate bin based on identification information collected by the identification system. In such aspects, the item verification system includes a presence sensor detecting when the item is positioned within an opening of the one or more bins. In other such aspects, the item verification system includes a verification scanner or image capture device. In still other aspects, the item verification system includes an access door automatically opening or closing selectively allowing or preventing access to the one or more bins based on identification information collected by the identification system.

In accordance with aspects of the present invention, the smart return receptacle further includes a processor managing the director mechanism based on identification information collected by the identification system.

In accordance with aspects of the present invention, the smart return receptacle further includes a wireless communication device that exchanges data with a remote server.

In accordance with aspects of the present invention, the one or more bins include multiple reusable food or beverage returns.

In accordance with aspects of the present invention, the one or more bins comprise at least one reusable food or beverage return bin which is connected to a washing system.

In accordance with aspects of the present invention, the item identification system is capable of learning to identify new items.

In accordance with embodiments of the present invention, a method for sorting items to be discarded into a smart return receptacle is provided. The method includes an item identification system identifying an item to be discarded into one or more bins of the smart return item receptacle, a director mechanism facilitating delivery of the identified item to an appropriate bin of the one or more bins of the smart return receptacle. Identifying an item is performed by a scanner or image capture device of the item identification system performing a scan or image capture of the item; and referencing a data record to identify the item based on the scan or image capture of the item.

In accordance with aspects of the present invention, the scanner or image capture device is at least one of a camera, optical scanner, and RFID reader.

In accordance with aspects of the present invention, facilitating delivery of the identified item to the appropriate bin of the one or more bins comprises providing a visual indicator indicating the appropriate bin. In other aspects, access to an opening of the appropriate bin is provided. In some such aspects, this involves unlocking or opening an access door on the appropriate bin. In other such aspects, this involves moving the appropriate bin into a position where the opening of the appropriate bin is accessible. In still other such aspects, this involves mechanically conveying the identified item to the appropriate bin.

In accordance with aspects of the present invention, the method further includes verifying the identified item has been placed in the appropriate bin. In some such aspects, this involves sensing the identified item with a sensor in proximity to an opening of the appropriate bin.

### BRIEF DESCRIPTION OF THE FIGURES

These and other characteristics of the present invention will be more fully understood by reference to the following detailed description in conjunction with the attached drawings, in which:

FIG. 1 is an isometric view of an existing receptacle for sorting items to be discarded as known in the art;

FIG. 2 is an isometric view of a system which uses a vision system to detect items to be sorted and indicates the appropriate receptacle for the item;

FIG. 3 is an isometric view of a system similar to FIG. 2 which uses a barcode reader for detection in place of a vision system;

FIG. 4 is an isometric view of a system using a smartphone app to identify items which require sorting;

FIG. 5 is an isometric view of a system similar to FIG. 2 with the addition of access doors at the receptacle openings;

FIG. 6A is a top view of an array of receptacles on a rotating mechanism;

FIG. 6B is a side view of an array of receptacles with a conveyance system to deposit items into a particular receptacle;

FIG. 7 is an isometric view of a return receptacle for reusable items with identification system;

FIG. 8A is a side view of an opening of a return receptacle for reusable items with an item identification system and presence sensor;

FIG. 8B is a side view of an opening of a return receptacle for reusable items with a first and second identification system;

FIG. 8C is a side view of an opening of a return receptacle for reusable items with a first and second item identification system and a presence sensor;

FIG. 9A is an isometric view of a return receptacle for reusable beverage containers with an item identification system and multiple receptacle openings with doors sized for receiving said reusable beverage containers;

FIG. 9B is an isometric view of a return receptacle for reusable beverage containers and lids with an item identification system and multiple receptacle openings with doors sized for receiving said reusable beverage containers and lids;

FIG. 10 is an isometric view of a reusable beverage container washing system with an identification system;

FIG. 11 is a diagrammatic illustration of a network environment in which the smart return receptacle can be use, according to embodiments of the present invention; and

FIG. 12 is a diagrammatic illustration of a computing device and related hardware for use in implementation of the present invention.

### DETAILED DESCRIPTION

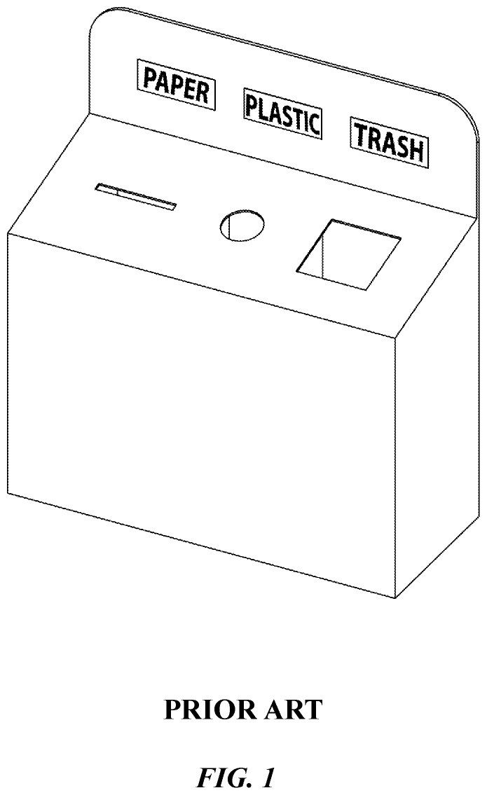

FIG. 1 shows a conventional system used for sorting various items intended to be deposited into the correct bin within the system. Such systems use signage, symbols, or receptacle openings of a particular perimeter profile shape and size to indicate where items are intended to be deposited. The system may contain multiple bins within one housing as shown, or separate housings for each type of item to be deposited. These systems rely on users to first understand the signage, and then have the diligence and courtesy to return items as appropriate. Predictably, items are deposited into the incorrect receptacle frequently.

Illustrative embodiments of the present invention relate to a smart return receptacle system which uses a detection system to guide the user to deposit items into the correct receptacle. The system detects the item to be deposited and provides guidance or instruction to properly deposit the item. In addition, or alternatively, the system allows access to only the appropriate receptacle opening. Additional detection systems and/or sensors may be provided to monitor or ensure only the appropriate items are deposited.

The smart return receptacle comprises one or more bins, an item identification system, and a director mechanism. The one or more bins receive returned or discarded items. The item identification system includes a processor and a scanner or image capture device in communication with the processor that reads identifying tags disposed on the items or performs a capture for character or object recognition. In various embodiments, the scanner or image capture device can be an optical scanner, a camera, or a radio frequency identification (RFID) reader, or any combination or equivalent thereof. The item identification system identifies items to be placed in the one or more bins when they are positioned within a predetermined range of the scanner or image capture device. The director mechanism directs an identified item to the appropriate bin. In various embodiments, the director mechanism can comprise visual indicators, access doors, revolving platforms, conveyer systems, or any combination thereof.

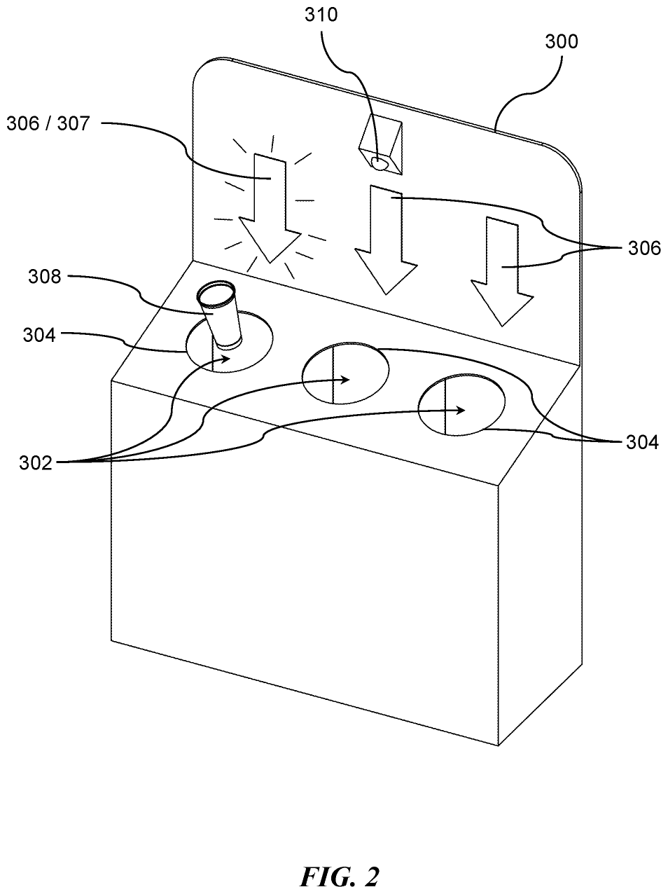

FIG. 2 through FIG. 12, wherein like parts are designated by like reference numerals throughout, illustrate an example embodiment or embodiments of a smart return receptacle that is sized, dimensioned, and configured as conventional trash, recycling, or return receptacle, according to the present invention. Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed, such as the size, shape, or type of elements or materials, in a manner still in keeping with the spirit and scope of the present invention.

FIG. 2 illustrates an example smart return receptacle 300 able to detect items 308 prior to depositing into a bin 302 of the receptacle 300 and highlight via visual indicators 306 the appropriate opening 304 in which to deposit said item 308. Here, the scanner or image capture device of the item identification system comprises a vision system, such as a camera 310, which can be used to detect the item 308 intended to be deposited, such as an item that is in a person's hand. Once that item 308 is detected by the identification system, the item 308 can be cross-referenced against a data record, such as a look-up table, directory, library, database, or other such file or record which contains the information regarding the correct bin 302 of receptacle 300 for that particular item. In this example the director mechanism of the receptacle 300 then provides feedback to the user, such as by highlighting the correct bin 302 to guide the user to deposit the item 308 into the appropriate bin 302 of the receptacle 300, as shown in FIG. 2 with a visual indicator 306, such as an illuminated arrow 307 above the bin opening 304 on the left side. Such feedback of the director mechanism could also be provided in other ways, such as illuminating the bin 302 or bin opening 304, or providing a central monitor with a visual indication of the correct receptacle, or other methods that will make it apparent to an untrained user which is the appropriate bin 302 or opening 304 to deposit items. Such feedback of the director mechanism can additionally include audible indicators so that people with vision impairment are able to deposit items correctly. In some embodiments, when an item 308 cannot be identified by the identification system, the item identification system may be trained by tracking which bin opening 304 the item 308 is placed into and creating an entry in the data record for future reference.

The item identification system as described can continue to monitor the user after the correct receptacle opening has been identified to ensure the correct item is actually deposited as intended. The receptacle 300 can then provide positive feedback to reinforce correct behavior, or alert the user and/or others, either at the same location or remotely, if incorrect items 308 are being inserted into bins 302.

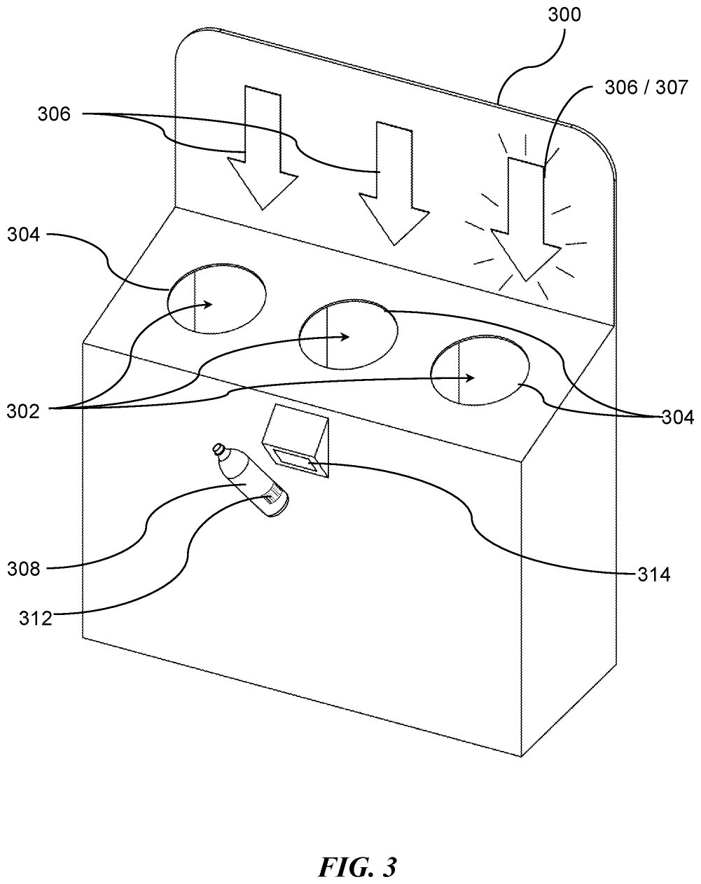

The vision system having a camera 310 for detection of items 308 as shown in FIG. 2 is required when items 308 do not contain any distinguishing marks, such as disposable flatware at a self-service restaurant. However, because of the complexity of the hardware and programming of such identification systems, such identification systems may be cost prohibitive for some situations. Simpler and more cost-effective identification systems may be used when the items 308 to be deposited contain a distinguishing mark, such as a barcode 312. As shown in FIG. 3, an optical scanner, such as a barcode reader 314 is configured to identify the item by reading the corresponding barcode 312 on the item 308. The item identification system will then reference a data record and provide feedback to the user as previously described. This type of item identification system is helpful for recyclable containers and packaging which are required to be sorted since the containers and packaging typically contain a barcode 312. Although barcodes 312 are the most common identification device found on retail products, the same method can be used to identify other distinguishing markers, such as QR codes, optical character recognitions, RFID tags, combinations thereof, equivalents thereof, or the like.

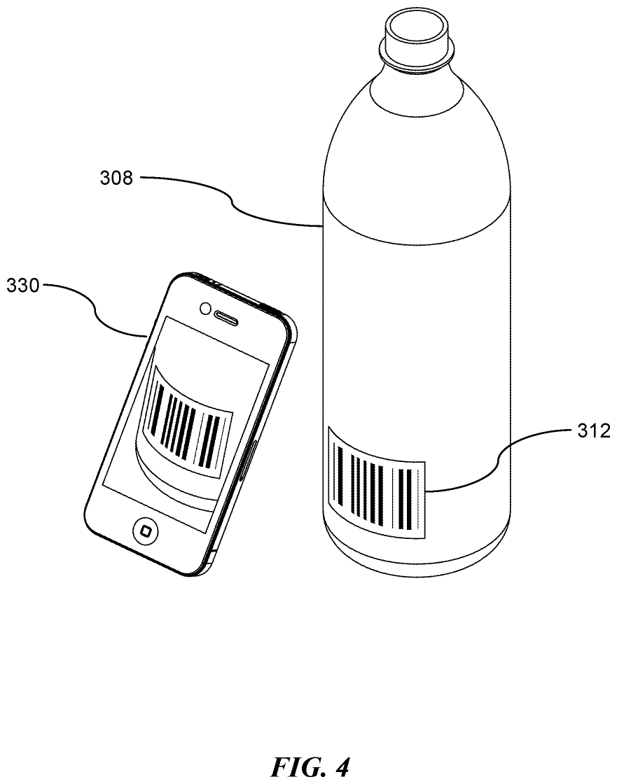

The item identification system of the receptacle 300 shown in FIG. 3 is intended for commercial applications. A similar method can be used for sorting residential recycling as shown in FIG. 4. A smartphone 330 or similar device can be used to identify a barcode 312 or other distinguishing mark, or to visually identify the item 308 by comparing to a known data record of pictures. Once the item 308 is identified, feedback is provided to the user about proper recycling methods, or if the item is not recyclable. Since recycling standards are different depending on the particular municipality, the data record can be customized to the user's locale to provide appropriate feedback to each user. In some embodiments, the smartphone may be in communication with the smart return receptacle 300 where the identification information obtained by the smartphone 330 can be used by the director mechanism of the receptacle 300 to direct the identified item 308 into the appropriate bin 302.

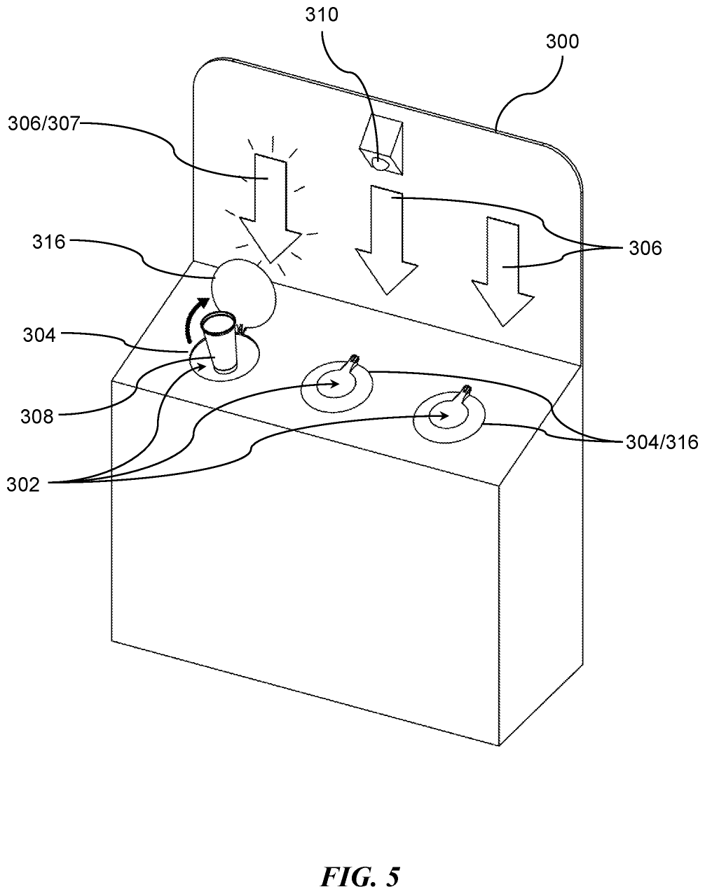

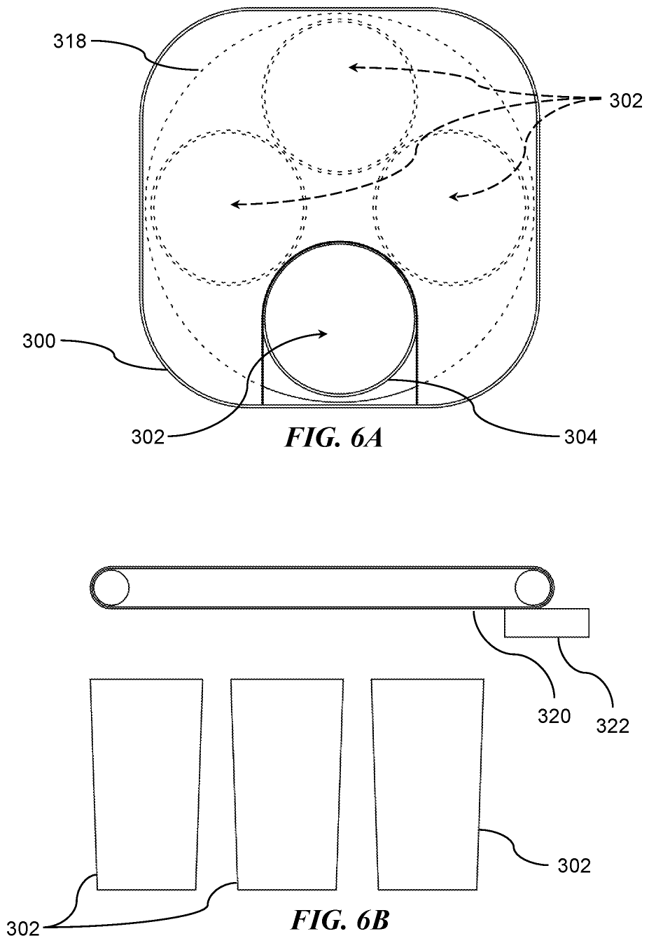

Although the smart return receptacles 300 or identification systems as previously described are able to actively guide the user to deposit items 308 into the correct bin 302, the receptacles 300 still require the user to interpret the feedback correctly and then act accordingly. A further embodiment of the invention the director mechanism additionally prevents access to bin openings 304 unless the appropriate items 308 are detected. The smart return receptacle is similar to FIG. 2 with the addition of locking receptacle doors is shown in FIG. 5. While highlighting the correct bin opening 304 as previously described, the door 316 of the corresponding bin opening 304 is unlocked or automatically opened to allow the item to be inserted. Additional methods for limiting access to only the intended bin 302 by the director mechanism are also practicable, such as the user being presented with only the correct bin opening 304 by moving a series of bins 302 using a moving platform, such as a revolving platform 318 as shown in FIG. 6A. Alternatively, the director mechanism can involve the user loading an identified item or items 308 intended for a particular bin 302 onto a conveyance system, such a conveyer belt 320 having a loader/unloader 322 configured to selectively grip and release the item 308 which will move the item or items 308 and direct them into the correct bin 302 as shown in FIG. 6B. While limiting access to the bins 302 further reduces the probability of incorrect items ending up in bins 302, additional or alternate items than the identified item 308 may possibly be inserted while the bin 302 is accessible. Additional monitoring of the items 308 inserted, such as by the item identification system described previously, could be used to further eliminate that possibility.

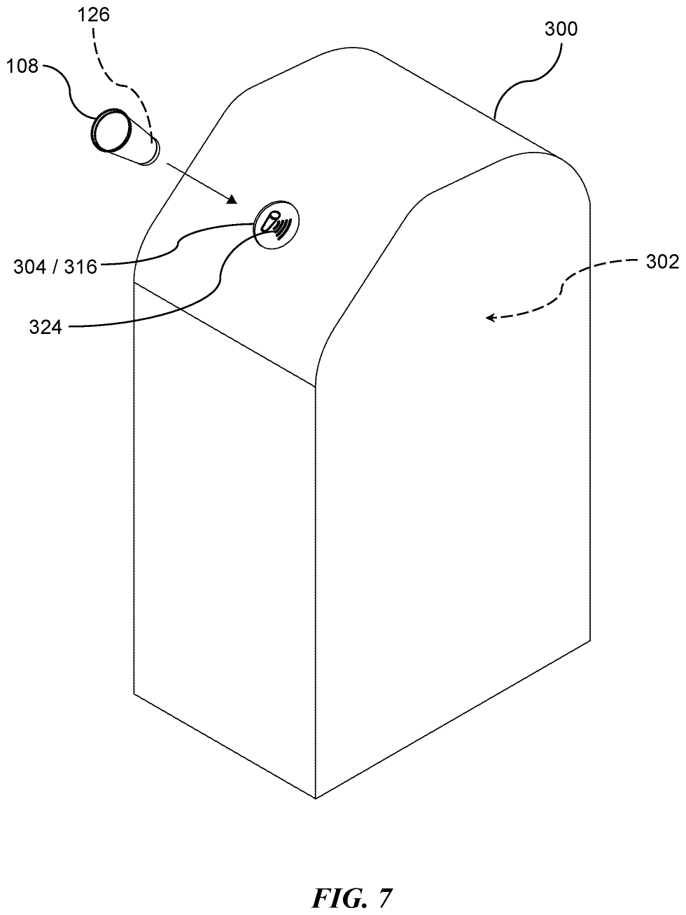

The embodiments as previously described are primarily helpful to greatly increase the accuracy of discarded items being placed into the correct bin 302, such as separating returnable items, compostable items, recyclable items, and common trash. In other embodiments, the aspects of the invention for guiding a user to the correct receptacle are not required and the detection and limiting receptacle opening access devices are used to keep unwanted items out of a particular receptacle, such as for a smart return receptacle 300 where the items 308 the receptacle is configured to receive are reusable food and beverage containers 108. FIG. 7 shows a smart return receptacle 300 for reusable food or beverage containers 108 which scans an identification tag 126 on the container 108 to allow access to the opening 304 of the bin 302. Here, the item identification system uses an RFID reader 324 and the director mechanism includes an access door 316 that is opened to grant access to the opening 304 of the bin 302. However, other means of identification, such as a barcode, QR code, near-field communication (NFC), or optical character recognition, and other means of directing the depositing of items, such as automatically opening a door and/or other indicators, as previously described are also practicable.

Additional means to ensure only the identified item 308, such as a reusable food or beverage container 108, are deposited into the correct bin 302 after access has been granted to the bin opening 304 have been previously discussed, such as a vision system of the item identification system used to monitor items as they are deposited. In another embodiment, an additional item verification system is used to identify the item 308 deposited into the bin opening 304 prior to allowing the item 308 to move or drop further into the receptacle or any other action to occur.

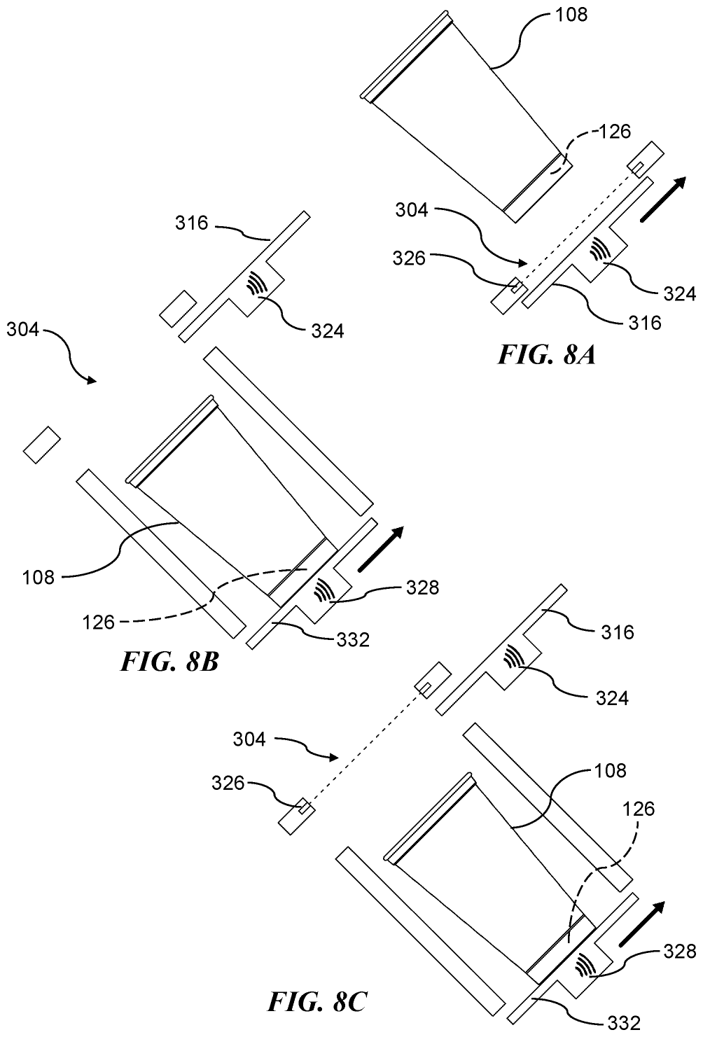

FIG. 8A shows the opening 304 of such a receptacle 300 wherein the item identification system includes an RFID reader 324 in the access door 316 of the director mechanism. The RFID reader 324 can read an identification tag 126, here an RFID tag, of a reusable food or beverage container 108 or other type of item 308. When the identification information of the identification tag 126 is successfully matched to a data record as previously discussed, the director mechanism will automatically open the access door 316 to the bin opening 304. The item verification system of this embodiment includes a presence sensor 326. The RFID reader 324 and an additional presence sensor 326, such as a through-beam sensor, are both positioned in close proximity to the bin opening 304 such that when the container 108 is identified and the door 316 is opened, the intended item must be deposited. Once the presence sensor 326 no longer detects an item, either because the container was successfully deposited, or it was pulled back away from the bin opening 304, possibly to allow room to attempt to insert a different item, the door 316 will automatically close. In other embodiments, instead of a presence sensor 326, a second RFID reader 328, or a second access door 332 or any combination thereof can be provided. An example of a second RFID reader 328 provided on a second access door 332 inside the receptacle opening 304 that is used to verify the intended item has been deposited through the opening 304 is shown in FIG. 8B. Once an item 308, such as an identified reusable food or beverage container 108 is verified, the first access door 316 will close so that no other items can be deposited, then the inner second access door 332 will move to allow the identified and verified item 308 to enter further into the bin 302. In yet another embodiment as shown in FIG. 8C, a second RFID reader 328 on a second access door 332 are used in conjunction with a presence sensor 326 to further ensure only the intended container 108 can be deposited by combining the aspects as previously discussed. Additionally, when the correct container 108 is verified by the second RFID reader 328 as being successfully loaded into the bin opening 304, the presence sensor 326 can be used as a safety device to ensure a user's hands or other items are clear of the first access door 316 prior to closing.

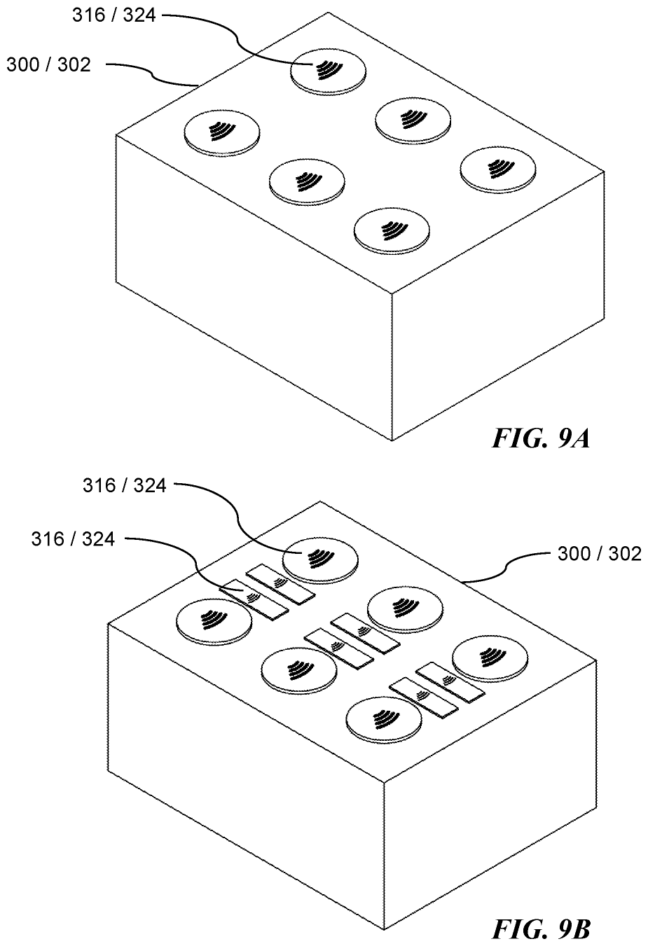

In some embodiments, smart return receptacles 300, particularly those used for reusable food and beverage containers 108, may contain multiple bins 302 or openings 304 intended for the same item 308 or type of item, such as a type of reusable food or beverage container 108, so that the containers 108 are organized within the receptacle 300 after being deposited. Such organized bins 302 may be easier for handling as the entire bin 302 may be emptied or unloaded according to the type of item 308 deposited in the bin 302. In embodiments where the item 308 is a reusable food or beverage container 108, utensil, or accessory, the bin 302 can be entered directly into a washing system such that the bin 302 and all contents are washed such that they can be reused. In further such embodiment, each bin 302 can be for a specific type of reusable food or beverage container 108, utensil, or accessory. Such receptacles 300 may contain a scanner or image capture device, such as an RFID reader 324 in an access door 316 for each bin opening 304 as shown in FIG. 9A, or alternatively contain a single scanner or image capture device which will unlock or open some or all doors 316 as previously described. In another embodiment shown in FIG. 9B, the receptacle 300 may contain openings for different items, such as a drinking containers and lids, so that they can be contained and organized within the same receptacle 300. For such system, the cup and lid are each identified in order to open or unlock the corresponding door 316. In another embodiment, only one of the items 308, the cup for example, is identified and doors are open or unlocked for both the cup and corresponding lid. In yet another example, a single door 316 is open or unlocked for a bin opening 304 with a perimeter profile sized and shaped for receiving both a cup and a lid.

The bins 302 of a receptacle 300 as previously discussed are generally for containment, organization, or transportation of said items 308. In another embodiment, the receptacle 300 is designed to process such items 308 by washing, composting, compacting, or some other means such that the items 308 deposited into the receptacle 308 are processed without additional labor or input required. For example, one or more bins 302 of the receptacle 300 can include, incorporate, or otherwise be connected with a device having such functionality.

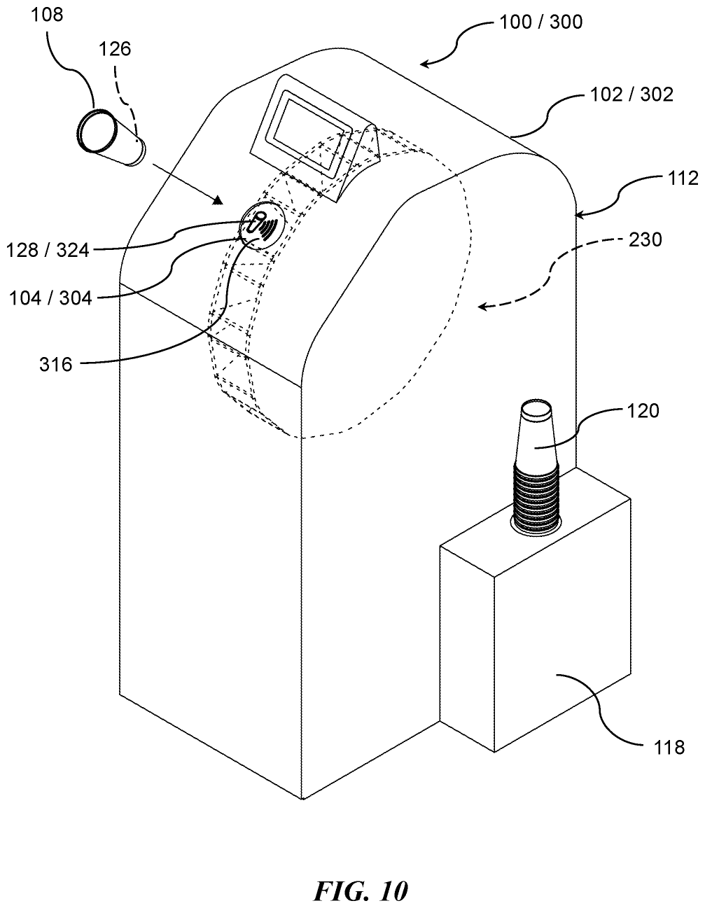

FIG. 10 shows a washing system 100 for reusable food or beverage containers 108 incorporated into or otherwise replacing a bin 102/302 of the smart return receptacle 300. Here the washing system 100 incorporated into the bin 302 has an opening 104/304 containing a door 316 which is unlocked or opened automatically when the correct container 108 is identified. The system as shown uses an RFID reader 128/324 to identify an identification tag 126, such as RFID tag, of the container 108 as previously described, although other detection devices or combination or devices as previously described are also practicable. Received containers 108 are transferred or otherwise conveyed to a washing chamber 230 of an automated washing subsystem 112 for washing. Washed containers 108 are then transferred or otherwise conveyed to an automated organizing and outputting subsystem 118. When the automated organizing and outputting subsystem 118 is an automated stacking subsystem, the clean reusable container 108 is nested in a container stack 120. Additionally, the return receptacle 300 or washing system 100 may contain or be connected to a tracking system used to track usage of the items, such as described in provisional applications 62/970,151 and 62/980,661, which are incorporated herein in their entirety.

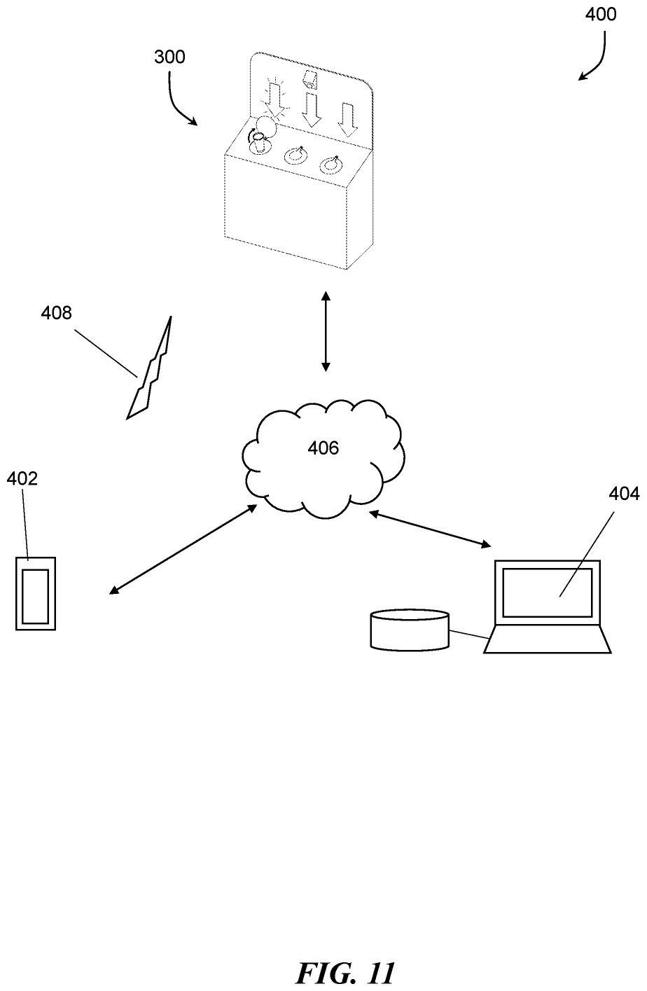

In some embodiments, the smart return receptacle 300 can communicate directly with the Internet or other devices using a wired connection, Wi-Fi®, Bluetooth® Ethernet, and/or cellular connectivity, or other wireless communication protocol. An example of such connectivity can be seen in FIG. 11.

In the exemplary network 400 of FIG. 11, the receptacle 300 may be in communication with one or more devices such as a personal electronic or computing device 402, such as a smart phone 330, tablet, or personal computer and a server 404. The communication may be over the internet 406 or through direct device to device communication 408 such as radio, Bluetooth®, or cellular communication, or the like. In some embodiments as described herein, the personal electronic or computing device 402, such as a smartphone 330, can act as a scanner or image capture device for the identification system. The personal electronic or computing device 402 may also be used to configure and control the receptacle 300. The server 404 may also be used to remotely configure and control the receptacle 300. In some embodiments, the server 404 stores the data record used by the item identification system of the receptacle 300 to identify items 308.

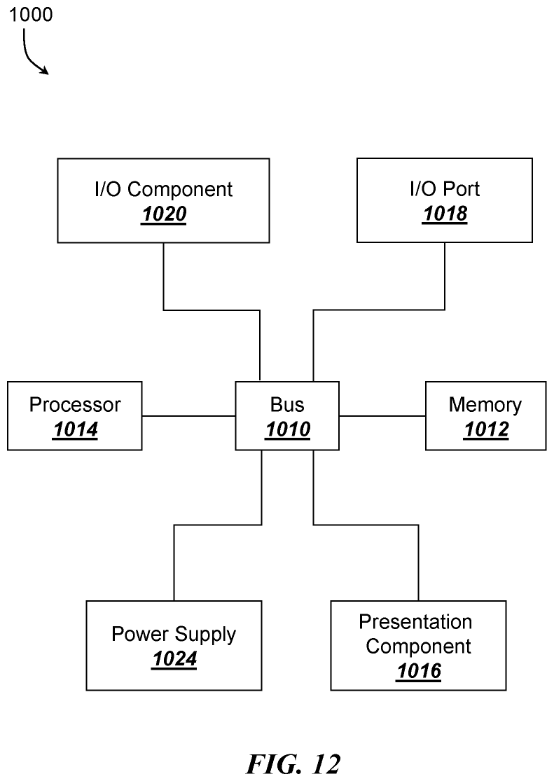

FIG. 12 depicts an example electronic, computer, or computing device 1000 that can be used to implement one or more aspects of the present invention, including the identification system, controlling the director mechanism, controlling washing system, connected systems, such as remote servers or personal electronic devices, as well as other functionality described herein. The functionality and hardware of such computing device 1000 may be implemented in any of the electronic hardware systems or subsystems described herein as involving or using a “computer” or “computing device” or the like, or related hardware for providing all or part of the described functionality, provided as a separate device or integrated into a system or subsystem described herein, as would be appreciated and understood by those of skill in the art. The terms “computer”, “computing device”, and the like utilized herein are intended to mean a processor at its most basic form, on up to more complex computing systems, including servers and cloud-based systems, in accordance with conventional meanings of such terms. However, for purpose of completeness, example components and related accessories that are intended to be encompassed by the use of the terms “computer”, “computing device”, “processor”, and the like will be provided below in example nonlimiting form.

The computing device 1000 is merely an illustrative example of a suitable computing environment and in no way limits the scope of the present invention. An “electronic device”, “remote device,” or “personal electronic device” as represented in figures and description herein, can include a “workstation,” a “server,” a “laptop,” a “desktop,” a “hand-held device,” a “mobile device,” a “tablet computer,” a “processor,” or other computing devices, as would be understood by those of skill in the art. Given that the computing device 1000 is depicted for illustrative purposes, embodiments of the present invention may utilize any number of computing devices 1000 in any number of different ways to implement a single embodiment of the present invention. Accordingly, embodiments of the present invention are not limited to a single computing device 1000, as would be appreciated by one with skill in the art, nor are they limited to a single type of implementation or configuration of the example computing device 1000.

The computing device 1000 can include a bus 1010 that can be coupled to one or more of the following illustrative components, directly or indirectly: a memory 1012, one or more processors 1014, one or more presentation components 1016, input/output ports 1018, input/output components 1020, and a power supply 1024. One of skill in the art will appreciate that the bus 1010 can include one or more busses, such as an address bus, a data bus, or any combination thereof. One of skill in the art additionally will appreciate that, depending on the intended applications and uses of a particular embodiment, multiple of these components can be implemented by a single device. Similarly, in some instances, a single component can be implemented by multiple devices. As such, the figures herein are merely illustrative of an exemplary computing device 1000 that can be used to implement one or more embodiments of the present invention, and in no way limits the invention.

The computing device 1000 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the computing device 1000.

The memory 1012 can include computer-storage media in the form of volatile and/or nonvolatile memory. The memory 1012 may be removable, non-removable, or any combination thereof. Exemplary hardware devices are devices such as hard drives, solid-state memory, optical-disc drives, and the like. The computing device 1000 can include one or more processors 1014 that read data from components such as the memory 1012, the various I/O components 1020, etc. The one or more processors 1014 may be part of or otherwise used in implementing the item identification system as well as the director mechanism of the smart return receptacle 300. Presentation component(s) 1016 present data indications to a user or other device. Exemplary presentation components include a display device, speaker, printing component, vibrating component, etc.

The I/O ports 1018 can enable the computing or electronic device 1000 to be logically coupled to other devices, such as I/O components 1020. Some of the I/O components 1020 can be built into the computing device 1000. Examples of such I/O components 1020 include a sensor (including but not limited to: a camera, optical scanner, RFID scanner, or the like), keypad, touchpad, joystick, recording or storage device, game pad,dd satellite dish, scanner, printer, wireless device, networking device, and the like, as appropriate.

As utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about”, “generally”, and “approximately” are intended to cover variations that may existing in the upper and lower limits of the ranges of subjective or objective values, such as variations in properties, parameters, sizes, and dimensions. In one non-limiting example, the terms “about”, “generally”, and “approximately” mean at, or plus 10 percent or less, or minus 10 percent or less. In one non-limiting example, the terms “about”, “generally”, and “approximately” mean sufficiently close to be deemed by one of skill in the art in the relevant field to be included. As utilized herein, the term “substantially” refers to the complete or nearly complete extend or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A smart return receptacle comprising:
one or more bins for receiving items; and
an item identification system, comprising:
a processor;
a scanner or image capture device in communication with the processor that reads identifying tags disposed on the items or performs a capture for character or object recognition;
wherein the item identification system identifies items to be placed in the one or more bins when they are positioned within a predetermined range of the scanner or image capture device; and
a director mechanism facilitating delivery of an identified item to an appropriate bin based on item identification.

2. The smart return receptacle of claim 1, wherein the one or more bins comprise at least one of a trash bin, a recycling bin, and a reusable food or beverage return bin.

3. The smart return receptacle of claim 1, further comprising an opening for each of the one or more bins.

4. The smart return receptacle of claim 3, wherein each opening for each of the one or more bins comprises a predetermined perimeter profile shape that differs from each other opening.

5. The smart return receptacle of claim 1 wherein the scanner or image capture device comprises an optical scanner.

6. The smart return receptacle of claim 1, wherein the scanner or image capture device comprises a camera.

7. The smart return receptacle of claim 1, wherein the scanner or image capture device comprises a radio frequency identification (RFID) reader.

8. The smart return receptacle of claim 7, wherein the scanner or image capture device comprises a near-field communication (NFC) reader.

9. The smart return receptacle of claim 1, wherein the director mechanism comprises one or more visual indicators communicating feedback information to a user.

10. The smart return receptacle of claim 1, wherein the director mechanism comprises one or more access doors selectively allowing or preventing access to the one or more bins based on identification information collected by the identification system.

11. The smart return receptacle of claim 1, wherein the director mechanism comprises a moving platform holding the one or more bins that moves the appropriate bin into position for receiving the identified item based on identification information collected by the identification system.

12. The smart return receptacle of claim 1, wherein the director mechanism comprises a conveyer system that delivers an identified item to the appropriate bin based on identification information collected by the identification system.

13. The smart return receptacle of claim 1, wherein the director mechanism comprises an item verification system for verifying that the identified item is received by the appropriate bin based on identification information collected by the identification system.

14. The smart return receptacle of claim 13, wherein the item verification system comprises a presence sensor detecting when the item is positioned within an opening of the one or more bins.

15. The smart return receptacle of claim 13, wherein the item verification system comprises a verification scanner or capture device.

16. The smart return receptacle of claim 13, wherein the item verification system comprises an access door automatically opening or closing selectively allowing or preventing access to the one or more bins based on identification information collected by the identification system.

17. The smart return receptacle of claim 1, further comprising a processor managing the director mechanism based on identification information collected by the identification system.

18. The smart return receptacle of claim 1 further comprising a wireless communication device that exchanges data with a remote server.

19. The smart return receptacle of claim 1, where the one or more bins comprise multiple reusable food or beverage returns.

20. The smart return receptacle of claim 1, wherein the one or more bins comprise at least one reusable food or beverage return bin which incorporates a washing system.

21. The smart return receptacle of claim 1, wherein the item identification system can learn to identify new items.

22. A method for sorting items to be discarded into a smart return receptacle, the method comprising:
an item identification system identifying an item to be discarded into one or more bins of the smart return receptacle by:
a scanner or image capture device of the item identification system scanner or capturing an image of the item; and
referencing a data record to identify the item based on the scan or image capture; and
a director mechanism facilitating delivery of the identified item to an appropriate bin of the one or more bins of the smart return receptacle.

23. The method of claim 22, wherein the scanner or image capture device comprises at least one of a camera, optical scanner, and RFID reader.

24. The method of claim 22, wherein facilitating delivery of the identified item to the appropriate bin of the one or more bins comprises providing a visual indicator indicating the appropriate bin.

25. The method of claim 22, wherein facilitating delivery of the identified item to the appropriate bin of the one or more bins comprises providing access to an opening of the appropriate bin.

26. The method of claim 25, wherein providing access to an opening of the appropriate bin comprises unlocking or opening an access door on the appropriate bin.

27. The method of claim 25, wherein providing access to an opening of the appropriate bin comprises moving the appropriate bin into a position where the opening of the appropriate bin is accessible.

28. The method of claim 22, wherein facilitating delivery of the identified item to the appropriate bin of the one or more bins comprises mechanically conveying the identified item to the appropriate bin.

29. The method of claim 22, further comprising:
verifying the identified item has been placed in the appropriate bin.

30. The method of claim 29, wherein verifying the identified item has been placed in the appropriate bin comprises sensing the identified item with a sensor in proximity to an opening of the appropriate bin.
